(19) United States
(12) Patent Application Publication
(10) Pub. No.: US 2026/0194424 A1
(43) Pub. Date: Jul. 9, 2026

(54) DETECTION SPECIMEN AND MANUFACTURING METHOD THEREOF

(71) Applicant: China Nuclear Power Engineering Co., Ltd., Beijing (CN)

(72) Inventor: Jian YU, Beijing (CN)

(21) Appl. No.: 18/870,646

(22) PCT Filed: Oct. 19, 2022
(86) PCT No.: PCT/CN2022/126159

§ 371 Date: Nov. 30, 2024

(30) Foreign Application Priority Data
Jun. 14, 2022 (CN) 202210666014.1

(51) Int. Cl. G01N 1/28; B23K 20/10

(52) U.S. Cl. CPC G01N 1/286; B23K 20/10

(57) ABSTRACT

The present disclosure provides a detection specimen and a manufacturing method thereof. The detection specimen includes a specimen base, and a flaw unit including a platform and an accessory. The platform is disposed in a groove of the specimen base, and no machining is carried out or a first artificial flaw is machined in the platform. When the first artificial flaw is machined in the platform, a second artificial flaw corresponding to the platform is machined in the accessory which is matched and assembled with the platform, and the first and the second artificial flaws are spliced with each other to form a complete artificial flaw, or when no machining is carried out in the platform, a second artificial flaw is machined in the accessory and alone forms a complete artificial flaw. A detection specimen containing a high-precision artificial flaw of preset shape, size and position can be manufactured.

The present disclosure claims priority from the Chinese patent application CN 202210666014.1 titled “DETECTION SPECIMEN AND MANUFACTURING METHOD THEREOF” filed on Jun. 14, 2022.

### TECHNICAL FIELD

The present disclosure belongs to the field of nondestructive examination, and specifically relates to a detection specimen and a manufacturing method thereof.

### BACKGROUND

When a new nondestructive examination method is being researched and developed, or a certain nondestructive examination method is being verified, and when a structure is being subjected to safety assessment or a fracture mechanics assessment result is being verified, a detection specimen containing an artificial flaw of known shape, size and orientation is often desired to be manufactured. Generally, a verification mode of a nondestructive examination method is to examine a detection specimen or a group of detection specimens containing a known artificial flaw with an examination method to be verified. If the known artificial flaw can be detected and accurately and quantitatively described, or if the omission rate and the false alarm rate meet specified indexes, the adopted examination method is considered to pass the verification.

Generally, a common method for pre-burying an artificial flaw in a detection specimen includes: firstly, machining holes in a groove of the detection specimen or forming holes by welding metal block or the like, and then performing welding and filling. Such a detection specimen containing the artificial flaw has the disadvantages of great difference from the actual flaw in the product, and a shape and a size of the flaw difficult to control accurately, and the disadvantages are more remarkable when the preset artificial flaw has a relatively small size.

### SUMMARY

The technical problem to be solved by the present disclosure is to provide, in view of the above disadvantages in the existing art, a detection specimen and a manufacturing method thereof, where the detection specimen contains an artificial flaw of high precision and closer to reality and having preset position, shape, size and content.

In order to solve the above problem, the present disclosure adopts a technical solution as follows.

There is provided a detection specimen, including a specimen base, and a flaw unit including a platform and an accessory, where the platform is disposed in a groove of the specimen base, and no machining is carried out in the platform, or a first artificial flaw of a preset shape and/or preset size is machined in the platform. When the first artificial flaw is machined in the platform, a second artificial flaw of a preset shape and/or preset size corresponding to the platform is machined in the accessory which is matched and assembled with the platform, and the first artificial flaw and the second artificial flaw are spliced with each other to form a complete artificial flaw of a preset shape and/or preset size, or when no machining is carried out in the platform, a second artificial flaw of a preset shape and/or preset size is machined in the accessory which is matched and assembled with the platform, and the second artificial flaw alone forms a complete artificial flaw of a preset shape and/or preset size.

Preferably, when the first artificial flaw is machined in the platform, the first artificial flaw and the second artificial flaw each have a shape of a nonplanar type, a planar type or a nonplanar-planar composite type.

Preferably, the accessory has a trapezoidal shape, and a size of a residual material of the accessory after the second artificial flaw is machined is greater than a weld penetration of subsequent weld pass (weld bead) to be filled.

Preferably, multiple layers and multi-pass welded seams are deposited and filled in the groove of the detection specimen, one flaw unit is used and arranged in any weld pass, or at a junction of weld passes, or at a junction of a weld pass and a surface of the groove; or a plurality of flaw units are used and distributed in a plurality of weld passes or at different positions of one weld pass.

A method for manufacturing a detection specimen, characterized in including: welding and depositing a weld pass in a groove of a specimen base of the detection specimen; setting a flaw unit in the groove, including: machining a platform at a preset position in the groove of the specimen base, and machining a first artificial flaw of a preset shape and/or preset size in the platform, or no machining is carried out in the platform; and machining in an accessory, when the first artificial flaw is machined in the platform, a second artificial flaw of a preset shape and/or preset size corresponding to the first artificial flaw in the platform, mounting the accessory onto the platform, and splicing the first artificial flaw and the second artificial flaw to form a complete artificial flaw; or machining in the accessory, when no machining is carried out in the platform, a second artificial flaw of a preset shape and/or preset size, and forming a complete artificial flaw of a preset shape and/or preset size with the second artificial flaw alone. The method further includes: precisely welding, after the accessory is mounted onto the platform, contact interfaces between the accessory and the platform into an integral structure; and welding and depositing a subsequent weld pass in the groove on which the flaw unit is provided, to form the detection specimen.

Since the detection specimen of the present disclosure uses the platform and the accessory matched with the platform with the platform and the accessory containing flaws, and the artificial flaw in the detection specimen is formed by a precision welding method at the platform-accessory contact interface, a detection specimen containing a high-precision artificial flaw close to reality can be obtained by accurate controlling and machining of the position, the size, the orientation and the shape.

### BRIEF DESCRIPTION OF DRAWINGS

FIG. 1 is a schematic structural diagram of a detection specimen containing a plurality of artificial flaws according to an embodiment of the present disclosure;

FIG. 2 is a front view of FIG. 1;

FIG. 3 is a schematic structural diagram of a platform and a first artificial flaw according to an embodiment of the present disclosure;

FIG. 4 is a schematic structural diagram of an accessory and a second artificial flaw according to an embodiment of the present disclosure;

FIG. 5 is a schematic structural diagram of a first artificial flaw in the platform spliced with a second artificial flaw in the accessory according to an embodiment of the present disclosure;

FIG. 6 is a schematic structural diagram of a detection specimen containing one artificial flaw according to an embodiment of the present disclosure; and

FIG. 7 is a front view of FIG. 6.

In the Figures: 1—first weld layer, 2—second weld layer, 3—third weld layer, 4—fourth weld layer, 5—fifth weld layer, 6—first artificial flaw, 7—second artificial flaw, 8—platform, and 9—accessory.

### DETAIL DESCRIPTION OF EMBODIMENTS

The technical solution of the present disclosure will now be described clearly and completely with the help of accompanying drawings of the disclosure. Obviously, the described embodiments are part, but not all, of the embodiments of the disclosure. Based on the embodiments of the present disclosure, all the other embodiments obtained by those ordinary skilled in the art without any creative labor fall into the scope of the present disclosure.

It should be noted that in the description of the present disclosure, orientations or positional relationships referred by terms “upper”, “lower” and the like are based on the orientations or positional relationships shown in the drawings, and are merely for facilitating and simplifying description of the present disclosure, instead of indicting or implying that the device or component referred to must have a specific orientation or be configured or operated at a specific orientation, and thus should not be interpreted as limitations to the present disclosure.

In the description of the present disclosure, terms “first”, “second”, and the like are used for the purpose of illustration only and cannot be construed as indicating or implying a relative importance.

In the description of the present disclosure, it should be noted that, unless otherwise explicitly specified or limited, the terms “connected,” “disposed,” “mounted,” “fixed,” and the like are to be construed broadly, e.g., as being fixedly connected, detachably connected, or integrally connected; and may refer to direct connection, indirect connection via an intermedium, or internal communication of two elements. Those skilled in the art may understand the specific meanings of the above terms in the present disclosure according to the specific context.

The present disclosure provides a detection specimen, including a specimen base, and a flaw unit including a platform and an accessory. The platform is disposed in a groove of the specimen base, and no machining is carried out in the platform, or a first artificial flaw of a preset shape and/or preset size is machined in the platform. When the first artificial flaw is machined in the platform, a second artificial flaw of a preset shape and/or preset size corresponding to the platform is machined in the accessory which is matched and assembled with the platform, and the first artificial flaw and the second artificial flaw are spliced with each other to form a complete artificial flaw of a preset shape and/or preset size, or when no machining is carried out in the platform, a second artificial flaw of a preset shape and/or preset size is machined in the accessory which is matched and assembled with the platform, and the second artificial flaw alone forms a complete artificial flaw of a preset shape and/or preset size.

### Embodiment 1

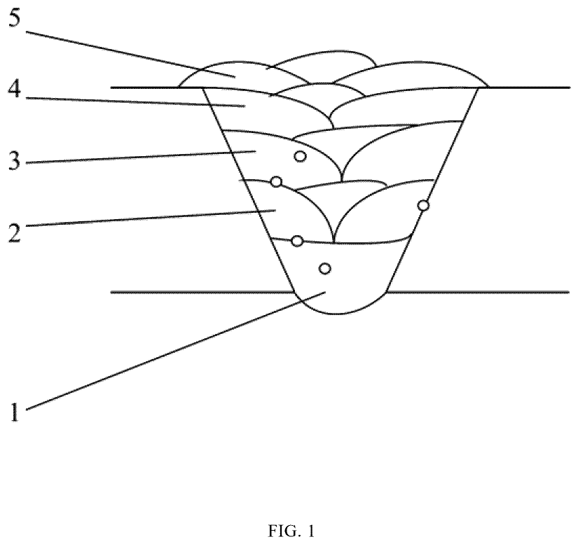

As shown in FIGS. 1, 2, 6 and 7, this embodiment discloses a detection specimen, including a specimen base and a flaw unit. As shown in FIGS. 3, 4 and 5, the flaw unit includes a platform 8 and an accessory 9. The platform 8 is disposed in a groove of the specimen base, and no machining is carried out in the platform 8, or a first artificial flaw 6 of a preset shape and/or preset size is machined in the platform 8. When the first artificial flaw 6 is machined in the platform 8, a second artificial flaw 7 of a preset shape and/or preset size corresponding to the platform 8 is machined in the accessory 9 which is matched and assembled with the platform 8, and the first artificial flaw 6 and the second artificial flaw 7 are spliced with each other to form a complete artificial flaw of a preset shape and/or preset size, or when no machining is carried out in the platform 8, a second artificial flaw 7 of a preset shape and/or preset size is machined in the accessory 9 which is matched and assembled with the platform 8, and the second artificial flaw 7 alone forms a complete artificial flaw of a preset shape and/or preset size.

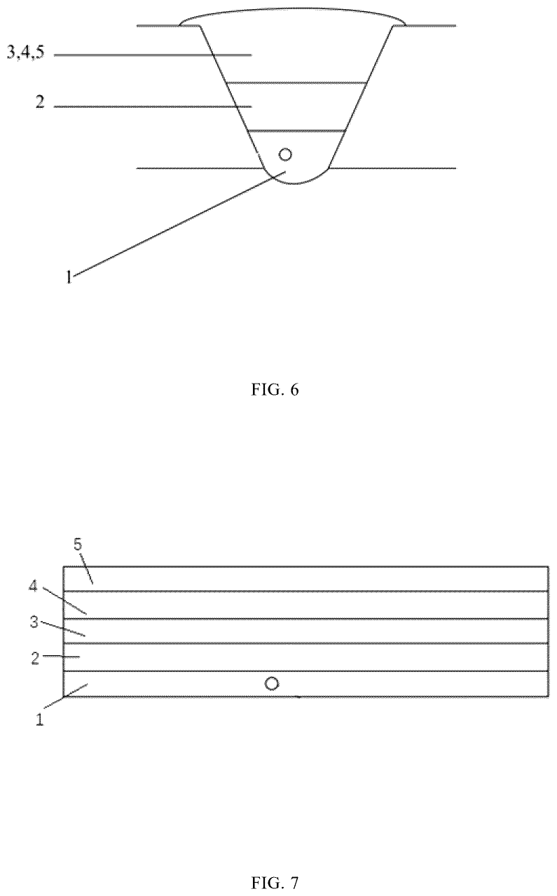

Optionally, as shown in FIGS. 6 and 7, only one flaw unit (i.e., one pair of platform 8 and accessory 9) may be provided in the V-shaped groove of the specimen base, and inside a first weld layer 1. The flaw unit may be alternatively disposed within any weld pass, or at a junction of weld passes, or at a junction of a weld pass and a surface of the groove.

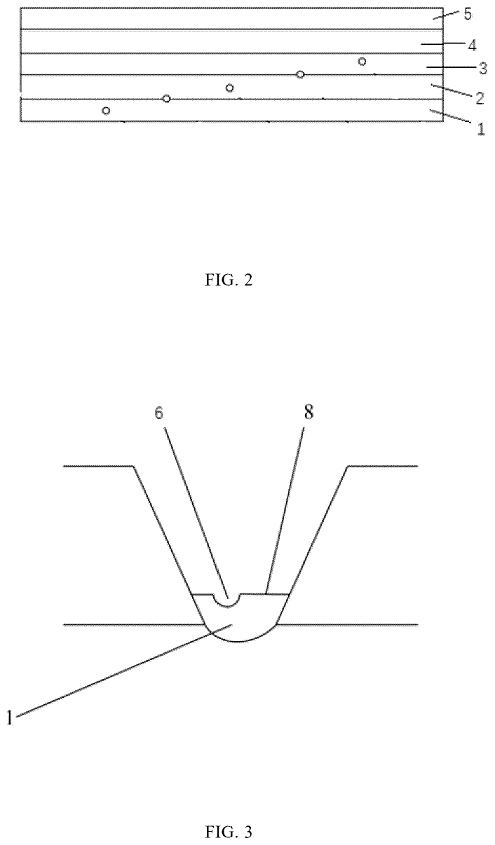

Alternatively, as shown in FIGS. 1 and 2, a plurality of flaw units (i.e., multiple pairs of platforms 8 and accessories 9) may be adopted and distributed in the groove of the specimen base. The groove of the specimen base has a V shape, in which five weld layers are filled, i.e., a first weld layer 1, a second weld layer 2, a third weld layer 3, a fourth weld layer 4 and a fifth weld layer 5 sequentially arranged from bottom to top. The five weld layers are sequentially stacked and welded, while the flaw units are disposed in the five weld layers. The first weld layer 1 is a backing weld layer; while the second weld layer 2, the third weld layer 3 and the fourth weld layer 4 are filling weld layers, and the fifth weld layer 5 is a covering weld layer. Specifically, five flaw units are provided, each having a nonplanar type spherical artificial flaw. A first artificial flaw is arranged in the first weld layer 1, a second artificial flaw is arranged at a junction of the first weld layer 1 and the second weld layer 2, a third artificial flaw is arranged at a junction of the second weld layer 2 and the V-shaped groove, a fourth artificial flaw is arranged at a junction of the second weld layer 2 and the third weld layer 3, and a fifth artificial flaw is arranged in the third weld layer 3. The plurality of flaw units may be distributed in a plurality of weld passes or at different locations of one weld pass.

As shown in FIGS. 3, 4 and 5, the flaw unit includes a platform 8 and an accessory 9. The platform 8 is disposed on the first weld layer 1 at a bottom of the V-shaped groove of the specimen base, a first artificial flaw 6 of a preset shape and/or preset size is provided in the platform 8, a second artificial flaw 7 of a preset shape and/or preset size corresponding to the platform 8 is provided in the accessory 9 which is matched and assembled with the platform 8, and the first artificial flaw 6 and the second artificial flaw 7 are spliced with each other to form a complete artificial flaw. The first artificial flaw 6 and the second artificial flaw 7 are shown as two hemispheres, which are spliced together to form a complete spherical artificial flaw. For simulating air hole, the specific shape of the artificial flaw may be set to a cavity sphere, a cavity hemisphere, a head-round-tail-tip-shaped cavity, a worm-shaped cavity, clustered cavities, each with 0.3 mm in diameter, and the like, as desired. Further, a smooth or rough inner surface of the cavity may be machined on an inner wall of the artificial flaw according to the specific requirements, and welding slag particles and powder may be filled into the cavity to simulate a slag inclusion flaw as desired.

Alternatively, in another case, a nonplanar-planar composite type artificial flaw is provided in the platform 8, a corresponding nonplanar-planar composite type artificial flaw is also provided in the accessory 9 which is matched and assembled with the platform 8, and a nonplanar-planar composite type artificial flaw of a preset shape and/or preset size is formed when the accessory 9 is matched and assembled with the platform 8.

Alternatively, in a further case, no artificial flaw is machined in the platform 8, while a planar type artificial flaw is provided in the accessory 9 which is matched and assembled with the platform 8, and a planar type artificial flaw of a preset shape and/or preset size is formed when the accessory 9 is matched and assembled with the platform 8.

The artificial flaw may include one or more of a nonplanar type, a planar type, or a nonplanar-planar composite type, as desired.

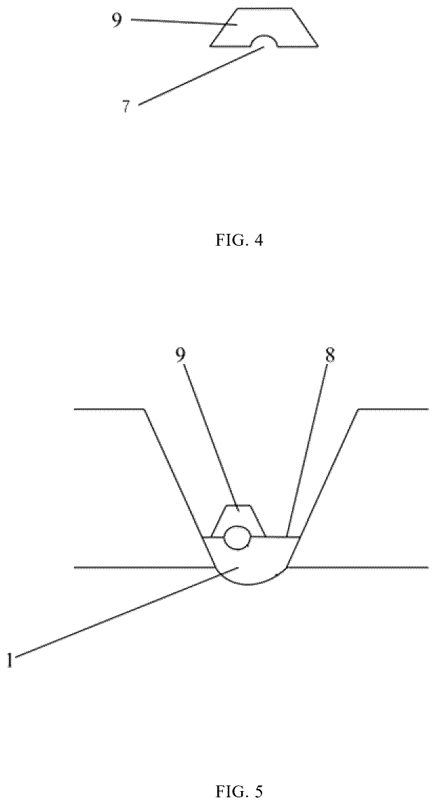

As shown in FIG. 4, the accessory 9 may have a trapezoidal shape, with sloping side surfaces that can facilitate better fusion of the accessory 9 and the weld layer 1 in subsequent filling and welding of the groove. A size of a residual material of the accessory 9 after the second artificial flaw 7 is machined is greater than a weld penetration of subsequent weld pass to be filled, which can guarantee that the shape and size of the second artificial flaw 7 will not change due to the weld penetration of the subsequent weld pass to be filled.

### Embodiment 2

This embodiment discloses a method for manufacturing a detection specimen which, as shown in FIGS. 3, 4 and 5, includes:
welding and depositing a weld pass in a groove of a specimen base of the detection specimen; and
setting a flaw unit in the groove, which specifically includes: machining a platform 8 at a preset position in the groove of the specimen base, and machining a first artificial flaw 6 of a preset shape and/or preset size in the platform 8, or no machining is carried out in the platform 8; and machining in an accessory 9, when the first artificial flaw 6 is machined in the platform 8, a second artificial flaw 7 of a preset shape and/or preset size corresponding to the first artificial flaw 6 in the platform 8, mounting the accessory 9 onto the platform 8, and splicing the first artificial flaw 6 and the second artificial flaw 7 to form a complete artificial flaw; or machining in the accessory 9, when no machining is carried out in the platform 8, a second artificial flaw 7 of a preset shape and/or preset size, and forming a complete artificial flaw of a preset shape and/or preset size with the second artificial flaw 7 alone.

The method further includes: precisely welding, after the accessory 9 is mounted onto the platform 8, contact interfaces between the accessory 9 and the platform 8 into an integral structure; and welding and depositing a subsequent weld pass in the groove on which the flaw unit is provided, to form the detection specimen.

Specifically, as shown in FIG. 3, a weld layer 1 is welded and deposited in the groove of the specimen base of the detection specimen, and on the weld layer 1: a platform 8 is machined, and a hemispherical first artificial flaw 6 of a preset shape and/or preset size is machined in the platform 8; or a platform 8 is machined, and a planar type artificial flaw is machined in the platform 8, and then a hemispherical first artificial flaw 6 is machined in a middle part of the platform, thereby forming a nonplanar-planar composite type artificial flaw; or a platform 8 is machined, and then, the platform 8 is not subjected to any machining.

As shown in FIG. 4: a hemispherical second artificial flaw 7 of a preset shape and/or preset size corresponding to the platform 8 is machined in the accessory 9; or a corresponding nonplanar-planar composite type artificial flaw is machined in the accessory 9 by imitating the above steps; or a planar type artificial flaw is machined in the accessory 9.

As shown in FIG. 5, the accessory 9 is mounted onto the platform 8, and: with such combination, the hemispherical first artificial flaw 6 and the hemispherical second artificial flaw 7 are spliced with each other to form a complete spherical artificial flaw; or with such combination, a nonplanar-planar composite type artificial flaw is spliced; or with such combination, a complete planar type artificial flaw is formed inside the accessory 9 alone.

In some embodiments, two detection specimens are used, on which weld passes are deposited through a same welding process. Then, a platform 8 having a first artificial flaw 6 of a preset shape/size is machined in the groove of the specimen base of one of the detection specimens, and artificial flaws at different depths can be obtained by adjusting a height of the platform 8.

An accessory 9 is cut from the other detection specimen and is machined to have a second artificial flaw 7 of a preset shape/size. Since the two detection specimens adopt the same welding process, the physical characteristics reflected by nondestructive examination of a material of the weld layer 1 are the same as or close to the physical characteristics reflected by nondestructive examination of a material of the accessory 9.

As shown in FIG. 5, a lower surface of the accessory 9 containing the second artificial flaw 7 is attached to an upper surface of the platform 8, and the first artificial flaw 6 and the second artificial flaw 7 are spliced into an integral artificial flaw. The contact interfaces between the accessory 9 and the platform 8 are precisely welded into an integral structure in a special method (such as ultrasonic welding, diffusion welding or thermocompression welding, or the like), and an artificial flaw of a preset shape, such as a cavity sphere with a diameter of about 0.3 mm, is formed inside a boss formed after the welding. If the accessory 9 has a relatively large size, the contact interfaces between the accessory 9 and the platform 8 may be precisely welded by an ultrasonic welding step by step in a superimposed manner, or a thickness of the accessory 9 may be increased by a shallow penetration mode such as laser welding or cold metal transition.

When the contact interfaces between the accessory 9 and the platform 8 are precisely welded, each weld layer of the weld pass in the groove is filled to form a detection specimen containing an artificial flaw.

The detection specimen is subjected to nondestructive examination in a conventional or special nondestructive examination method, such as radiographic examination, ultrasonic examination, industrial CT, and the like. The shape, size and other data of the artificial flaw obtained by the nondestructive examination is compared with an expected target value, and if there is a large deviation, the detection specimen is re-manufactured, and the shapes, sizes and other data of the first artificial flaw 6 and the second artificial flaw 7 are fed back and adjusted during manufacture of the detection specimen, until a detection specimen having the preset position, shape, size and content is obtained.

It will be appreciated that the above implementations are merely exemplary implementations for the purpose of illustrating the principle of the present disclosure, and the present disclosure is not limited thereto. It will be apparent to one of ordinary skill in the art that various modifications and variations may be made without departing from the spirit or essence of the present disclosure. Such modifications and variations should also be considered as falling into the protection scope of the present disclosure.

1. A detection specimen, characterized in that comprising a specimen base, and a flaw unit comprising a platform (8) and an accessory (9), wherein
the platform (8) is disposed in a groove of the specimen base, and no machining is carried out in the platform, or a first artificial flaw (6) of a preset shape and/or preset size is machined in the platform,
when the first artificial flaw (6) is machined in the platform (8), a second artificial flaw (7) of a preset shape and/or preset size corresponding to the platform (8) is machined in the accessory (9) which is matched and assembled with the platform (8), and the first artificial flaw (6) and the second artificial flaw (7) are spliced with each other to form a complete artificial flaw of a preset shape and/or preset size, or
when no machining is carried out in the platform (8), a second artificial flaw (7) of a preset shape and/or preset size is machined in the accessory (9) which is matched and assembled with the platform (8), and the second artificial flaw (7) alone forms a complete artificial flaw of a preset shape and/or preset size.

2. The detection specimen according to claim 1, characterized in that when the first artificial flaw (6) is machined in the platform (8), the first artificial flaw (6) and the second artificial flaw (7) each have a shape of a nonplanar type, a planar type or a nonplanar-planar composite type.

3. The detection specimen according to claim 1, characterized in that the accessory (9) has a trapezoidal shape, and a size of a residual material of the accessory (9) after the second artificial flaw (7) is machined is greater than a weld penetration of subsequent weld pass to be filled.

4. The detection specimen according to claim 1, characterized in that multiple layers and multi-pass welded seams are deposited and filled in the groove of the detection specimen,
one flaw unit is used and arranged in any weld pass, or at a junction of weld passes, or at a junction of a weld pass and a surface of the groove;
or a plurality of flaw units are used and distributed in a plurality of weld passes or at different positions of one weld pass.

5. A method for manufacturing a detection specimen, characterized in comprising:
welding and depositing a weld pass in a groove of a specimen base of the detection specimen;
setting a flaw unit in the groove, comprising:
machining a platform (8) at a preset position in the groove of the specimen base, and machining a first artificial flaw (6) of a preset shape and/or preset size in the platform (8), or no machining is carried out in the platform (8); and
machining in an accessory (9), when the first artificial flaw (6) is machined in the platform (8), a second artificial flaw (7) of a preset shape and/or preset size corresponding to the first artificial flaw (6) in the platform (8), mounting the accessory (9) onto the platform (8), and splicing the first artificial flaw (6) and the second artificial flaw (7) to form a complete artificial flaw; or
machining in the accessory (9), when no machining is carried out in the platform (8), a second artificial flaw (7) of a preset shape and/or preset size, and forming a complete artificial flaw of a preset shape and/or preset size with the second artificial flaw (7) alone;
precisely welding, after the accessory (9) is mounted onto the platform (8), contact interfaces between the accessory (9) and the platform (8) into an integral structure; and
welding and depositing a subsequent weld pass in the groove on which the flaw unit is provided, to form the detection specimen.

6. The detection specimen according to claim 2, characterized in that multiple layers and multi-pass welded seams are deposited and filled in the groove of the detection specimen,
one flaw unit is used and arranged in any weld pass, or at a junction of weld passes, or at a junction of a weld pass and a surface of the groove;
or a plurality of flaw units are used and distributed in a plurality of weld passes or at different positions of one weld pass.

7. The detection specimen according to claim 3, characterized in that multiple layers and multi-pass welded seams are deposited and filled in the groove of the detection specimen,
one flaw unit is used and arranged in any weld pass, or at a junction of weld passes, or at a junction of a weld pass and a surface of the groove;
or a plurality of flaw units are used and distributed in a plurality of weld passes or at different positions of one weld pass.
